(19) United States
(12) Patent Application Publication
(10) Pub. No.: US 2009/0120601 A1
(43) Pub. Date: May 14, 2009

(54) Papermaking Process

(76) Inventors: Michael Singh, West Yorkshire (GB); Robert Cockcroft, West Yorkshire (GB)

Correspondence Address: JoAnn Villamizar;Ciba Corporation/Patent Department, 540 White Plains Road, P.O. Box 2005, Tarrytown, NY, 10591, US

(21) Appl. No.: 11/666,885

(22) PCT Filed: Nov. 3, 2005
(86) PCT No.: PCT/EP05/11737

§ 371 Date: May 1, 2007

(30) Foreign Application Priority Data
Nov. 15, 2004 (GB) 0425101.3

(51) Int. Cl. D21H 17/52; D21H 17/34; D21H 17/37; C08F 20/10; C08F 20/56; D21H 17/45; D21H 21/16

(52) U.S. Cl. 162/164.3; 162/168.1; 162/164.6; 526/72; 526/303.1; 526/320

(57) ABSTRACT

A process of making paper by providing a cellulosic suspension comprising cellulosic fibres and optionally fillers, dewatering the cellulosic suspension on a wire or mesh to form a sheet and drying the sheet in which a polymeric additive is included in the process, in which the polymeric additive is a polymer comprising an ethylenically unsaturated water-soluble or potentially water-soluble monomer and an ethylenically unsaturated monomer carrying a reactive group.

The present invention relates to a process of making paper or paperboard. In particular the invention concerns improving the wet and dry strength of paper. The invention also concerns improved methods of internally or surface sizing of paper.

It is known that the paper strength characteristics tend to depend on the strength of individual cellulosic fibres and the ability to form strong bonds between cellulosic fibres and also the network of cellulosic fibres forming the cellulosic sheet. Poor quality cellulosic fibres can result in diminished strength characteristics. Furthermore, a non uniform distribution of cellulosic fibres that results in poor formation will also compromise strength of the cellulosic sheet that is formed

It is known to add polymeric additives to improve both the wet strength characteristics during papermaking and the dry strength characteristics of the paper thus formed. Typically, such polymeric additives that are commercially available include natural, partially modified, or synthetic water-soluble polymers, such as cationic starches, anionic starches, sodium carboxymethyl cellulose, polyacrylamides, anionic polyacrylamides and low molecular weight cationic polymers such as PolyDADMAC (diallyl dimethyl ammonium chloride), polyamide amine epichlorohydrin, polyamine epichlorohydrin, polydicyandiamide.

U.S. Pat. No. 3,311,594, discloses the preparation of Aminopolyamide-epichlorohydrin APAE wet strength resins. The resins are prepared by reacting epichlorohydrin with aminopolyamides, and the APAE resins can exhibit storage problems in concentrated form and gel during storage, although generally to a lesser extent than the GPA resins. For this reason it has been common practice to dilute the APAE resins to low solids levels to minimize gelation. The APAE resins impart dry and wet strength to paper.

Glyoxylated polyacrylamide-diallyldimethyl ammonium chloride copolymer resins are known for use as dry strength and temporary wet strength resins for paper. U.S. Pat. No. 4,605,702 teaches the preparation of a wet strength additive by glyoxalating an acrylamide copolymer having a molecular weight from about 500 to 6000. The resulting resins have limited stability in aqueous solution and gel after short storage periods even at non-elevated temperatures. Accordingly, the resins are typically supplied in the form of relatively dilute aqueous solutions containing only about 5-10 wt % resin.

U.S. Pat. No. 5,783,041 describes a method for improving the dry strength characteristics of paper by adding to a pulp slurry during a paper-making process a mixed resin solution containing an aminopolyamide-epichlorohydrin resin, a glyoxylated acrylamide-diallyldimethyl ammonium chloride resin, and a high charge density cationic resin.

U.S. Pat. No. 3,556,932 describes water-soluble, glyoxalated, acrylamide polymer wet strength agents. These wet-strength agents are made from polymers with molecular weights ranging from less than about 1,000,000, although preference is given to molecular weights less than about 25,000. The polymers are reacted with glyoxal in a dilute, aqueous solution to impart —CONHCHOHCHO functionalities onto the polymer and to increase the molecular weight of the polymer through glyoxal cross-links. Low molecular weight polymers and dilute solutions are required to impart at least a 6%-CONHCHOHCHO functionality to the polymers without infinitely cross-linking, or gelling, them, in which condition the polymers are useless for wet-strength applications. Even at these low solids concentrations (dilute conditions), cross-linking continues and limits the shelf life of the product. For example, commercial products, supplied as 10% solid solutions, gel within about 8 days at room temperature.

U.S. Pat. No. 5,041,503 attempts to overcome the disadvantages of glyoxylated polyacrylamides by producing them as microemulsions. The polymer molecules are said to be kept separate in the microemulsions thereby preventing cross-linking and thus enabling higher molecular weight polymers to be used. The polymers are said to be capable of providing improved or wet and dry strength in papermaking even when the polymers are cross-linked.

An article by Takuya Kitaoka et al, entitled “Novel paper strength additives containing cellulose binding domain of cellulase”, J Wood Sci (2001) 47: 322-324 describes covalently bonding cellulose binding domain proteins to anionic polyelectrolytes which are modified so that they are reactive towards the protein. The anionic polyelectrolytes contain carboxylic groups which are not directly reactive with the protein and reacted with a carbodiimide hydrochloride compound. The post treated reaction product was then combined with the cellulose binding domain protein to produce a synthetic polymer covalently bonded to the protein. The reaction product was found to be less effective as a dry or wet strength additive than conventional dry and wet strength additives.

Chemical Abstracts reference (accession number 2004: 222096) describes a similar disclosure to the Journal of Wood Science (2001) 47: 322-324.

In recent years there has been a trend towards recycling the process water used in papermaking processes, such that a high proportion of the white water is returned into the process to minimise the environmental impact in polluting watercourses and also the demand on fresh mains water introduced into the papermaking process. Recycling of process water tends to result in a buildup of ionic substances, such as anionic trash including lignosulphonates. Consequently the levels of ionic substances contained in the process water tends to be much higher in closed systems. Conventional ionic dry and wet strength resins employing electrostatic attraction have been found to be less effective in closed loop systems.

Although non-ionic conventional dry and wet strength resins do not tend to be adversely affected by the high electrolytic contents of closed loop papermaking systems, such conventional additives tend not to be as effective as the ionic additives, employed in papermaking systems in which there is less recycling of the process water.

It is an objective to provide a method for improving the dry strength of paper and wet strength during a papermaking process employing additives that are more effective than the aforementioned products described in the prior art. It is a further objective to provide a product that can be useful as an internal or surface sizing agent in papermaking processes.

According to the present invention we provide a process of making paper by providing a cellulosic suspension comprising cellulosic fibres and optionally fillers, dewatering the cellulosic suspension on a wire or mesh to form a sheet and drying the sheet in which a polymeric additive is included in the process, in which the polymeric additive is a polymer comprising an ethylenically unsaturated water-soluble or potentially water-soluble monomer and an ethylenically unsaturated monomer carrying a reactive group.

Unexpectedly, we have found that the polymeric additive is effective in improving the dry strength of the formed paper. In addition the additive also improves the wet strength carrying the papermaking process. Furthermore, the additive can be used as an internal sizing agent if applied in the wet end or as a surface sizing agent if applied to the said his own the formed sheet.

The ethylenically unsaturated monomer containing the reactive group may be any suitable monomer that will copolymerise with the water-soluble or potentially water-soluble monomer. The reactive group may be any suitable reactive group that desirably should be directly reactive with hydroxyl groups. In particular, it should be directly reactive with hydroxyl groups of cellulose. By directly reactive we mean that under suitable reaction conditions the reactive group will be reactive directly with at least one group of the cellulosic fibers and that it is unnecessary to chemically modify the group in order to render it reactive towards the cellulosic fibers. Particularly suitable reactive groups include epoxides, isocyanates, amido methylol groups. Particularly suitable monomer is which carried the reactive group include glycidyl acrylate, glycidyl methacrylate, allyl glycidyl ether, N-methyolacrylamide and 3-isopropenyl dimethyl benzyl isocyanate. Especially preferred amongst these are glycidyl acrylate and glycidyl methacrylate.

The water-soluble ethylenically unsaturated monomer desirably has a solubility in water of at least 5 g monomer per 100 mls of water at 25° C. When the monomer is potentially water-soluble it can be modified, for instance after polymerization, to provide a monomer unit that would have been soluble in water, for instance having the above defined solubility.

Suitable water-soluble or potentially water-soluble monomers are selected from the group consisting of acrylamide, methacrylamide, N-alkylacrylamides, hydroxy alkyl(meth)acrylates (e.g. hydroxyethyl acrylate), N-vinylpyrrolidone, vinyl acetate, vinyl acetamide, acrylic acid (or salts thereof), methacrylic acid (or salts thereof), itaconic acid (or salts thereof), crotonic acid (or salts), 2-acrylamido-2-methyl propane sulfonic acid (or salts thereof), (meth) allyl sulfonic acid (or salts thereof), vinyl sulfonic acid (or salts thereof). dialkyl amino alkyl (meth)acrylates or quaternary ammonium or acid addition salts thereof, dialkyl amino alkyl(meth) acrylamides or quaternary ammonium and acid addition salts thereof and diallyl dialkyl ammonium halide (e.g. diallyl dimethyl ammonium chloride). Preferred cationic monomers include the methyl chloride quaternary ammonium salts of dimethylamino ethyl acrylate and dimethyl aminoethyl methacrylate.

The ethylenically unsaturated monomer carrying the reactive group and the water-soluble ethylenically unsaturated monomer can be prepared synthetically from a suitable starting material and using synthetic catalysts or alternatively by biocatalytically converting a suitable substrate that is capable of being converted into the ethylenically unsaturated monomer. Typically the substrate is brought into contact with a biocatalyst and thereby converting the substrate into the ethylenically unsaturated monomer containing the cellular material and optionally components of a fermentation. Alternatively the ethylenically unsaturated monomer can be produced as a product of the fermentation process.

Desirably the polymeric additive may be formed from a monomer blend comprising water-soluble or potentially water-soluble ethylenically unsaturated monomer and up to 10 mole % of an ethylenically unsaturated monomer carrying a reactive group (as defined previously). The preferred amount of monomer containing the reactive group is generally up to 5 mole %. Usually the reactive group containing monomer will be present in an amount of at least 0.0001 mole %, preferably at least 0.001 mole %. The polymeric additive may be formed entirely of the monomer containing the reactive group and the water-soluble or potentially water-soluble monomer. Typically the water-soluble or potentially water-soluble monomer may be present in amount of up to 99.9999 mole %, preferably up to 99.999 mole %.

It may be desirable to include other ethylenically unsaturated monomers, for instance acrylic esters such as methyl acrylate, methyl methacrylate, ethyl acrylate, ethyl methacrylate, propyl acrylate, propyl methacrylate, n-butyl acrylate, n-butyl methacrylate, iso butyl acrylate, iso butyl methacrylate, n-hexyl acrylate, n-hexyl methacrylate, 2-ethylhexyl acrylate, 2-ethylhexyl methacrylate, stearyl acrylate and stearyl methacrylate; styrene; halogenated monomers such as vinyl chloride and vinylidene chloride. The amount of other monomer will typically be up to 50 mole % although usually will be up to 20 mole %, and more desirably will be less than 10 mole %.

More preferably the polymeric additive is formed from a monomer blend comprising 50 to 99.995 mole % water-soluble or potentially water-soluble ethylenically unsaturated monomer; 0.005 to 2 mole % ethylenically unsaturated monomer carrying a reactive group; and 0 to 50 mole % other ethylenically unsaturated monomer. More preferably still the amount of water-soluble or potentially water-soluble monomer will be between 80 (especially above 90) and 99.995 mole % and the amount of other ethylenically unsaturated monomer (if included) will be up to 20 mole % (especially below 10 mole %).

A particularly preferred polymeric additive is formed from a monomer blend comprising acrylamide and glycidyl methacrylate. Especially preferred is the polymer in which the amount of glycidyl methacrylate is as defined previously for the reactive group containing monomer. A particularly preferred polymer will contain between 0.005 and 5 mole % glycidyl methacrylate the remainder being acrylamide.

The polymeric additive of the invention may have a weight average molecular weight as low as a few thousand, for instance 6000 or 7000 or may be very high, for instance several tens of millions. However, we have found that when the polymer of the invention is for use as a dry strength additive in a paper making process it is preferred that the polymer has a weight average molecular weight of below one million. More preferably the weight average molecular weight will be below 500,000, especially within the range 50,000 to 300,000, in particular between 100,000 and 150,000.

The polymeric additive may be formed by combining the aforementioned monomers to form a monomer blend and then subjecting this monomer blend to polymerisation conditions. Typically this may include introducing polymerisation initiators and/or subjecting the monomer blend to actinic radiation, such as ultraviolet light and/or heating the monomer blend.

Preferably the monomer blend is dissolved or dispersed in an aqueous medium and water-soluble initiators are introduced into the aqueous medium in order to effect polymerization. It would be possible to effect polymerization using a variety of conventional initiator systems. For instance it is common practice to polymerise water soluble monomers using redox initiator couples, in which radicals are generated by admixing with the monomer a redox couple which is a reducing agent and an oxidising agent. It is also conventional practice to use either alone or in combination with other initiator systems a thermal initiator, which would include any suitable initiator compound that releases radicals at an elevated temperature. Other initiator systems include photo and radiation induced initiator systems, which require exposure to radiation to release radicals thereby effecting polymerisation. Other initiator systems are well known and well documented in the literature.

Typically redox initiators include a reducing agent such as sodium sulphite, sulphur dioxide and an oxidising compound such as ammonium persulphate or a suitable peroxy compound, such as tertiary butyl hydroperoxide etc. Redox initiation may employ up to 10,000 ppm (based on weight of monomer) of each component of the redox couple. Preferably though each component of the redox couple is often less than 1000 ppm, typically in the range 1 to 100 ppm, normally in the range 4 to 50 ppm. The ratio of reducing agent to oxidizing agent may be from 10:1 to 1:10, preferably in the range 5:1 to 1:5, more preferably 2:1 to 1:2, for instance around 1:1.

Polymerisation may also be effected by employing a thermal initiatior alone or in combination with other initiator systems, for instance redox initiators. Thermal initiators would include any suitable initiator compound that releases radicals at an elevated temperature, for instance azo compounds, such as azobisisobutyronitrile (AZDN), 4,4′-azobis-(4-cyanovalereic acid) (ACVA). Typically thermal initiators are used in an amount of up 10,000 ppm, based on weight of monomer. In most cases, however, thermal initiators are used in the range 100 to 5,000 ppm preferably 200 to 2,000 ppm, usually around 1,000 ppm.

The polymeric additive may be prepared as an aqueous solution of the polymer. This may for instance be relatively concentrated, for instance above 2% by weight, such as at least 5 or 10% by weight. Alternatively, the polymer may be prepared in particulate form, for instance as a powder. This may be achieved by drying a solution comprising the polymer and then breaking up the polymer to form a powdered product. Alternatively the polymer may be formed as a gel by polymerizing a solution of the monomer at a concentration of at least 30% and usually at least 50% by weight. The formed a gel can be comminuted, dried and then ground to form a powder according to conventional techniques that are documented in the literature. Alternatively, the polymer may be provided as either in bead form or as an emulsion by conducting reverse phase polymerisation of the monomer in a water immiscible liquid using a polymeric stabiliser. The polymeric stabiliser is generally an amphipathic stabiliser, for instance, formed from hydrophilic and hydrophobic acrylic monomers. Suitable methods are described in the literature, for instance details of suitable water immiscible liquids and stabilisers and/or surfactants are described in EP-A-150933 and EP-A-126528.

Suitable surfactants, non-aqueous liquids and polymeric stabilisers, and suitable conditions, are described in, for instance, EP-A-128661, EP-A-126528, GB-A-2,002,400, GB-A-2,001,083 or GB-A-1,482,515.

When making polymeric beads they would generally be substantially dry. Typically the size of the substantially dry beads is dictated by the size of the dispersed aqueous phase particles in the immiscible liquid. It is often desired that the dry particles are beads that have a size of at least 30 microns, often at least 100 microns, for instance up to 500 microns or up to 1 mm or even 2 mm or larger. With particles of this size, the substantially dry particles will be separated from the water immiscible liquid by filtration, centrifugation or other conventional separation methods and may be subjected to further drying after the separation. This further drying may be by solvent exchange but is preferably by warm air, for instance in a fluidised bed.

In one preferred form of the invention that polymeric additive is included before this cellulosic suspension is dewatered. Generally this will be before the cellulosic suspension is drained on the machine wire or mesh, and usually this will be before the headbox.

Preferably, the polymeric additive is a dry strength additive. The polymer when used for improving the dry strength of paper is desirably included into the wet end of the papermaking process. Typically the polymeric dry strength additive may be included with any other stock components, for instance cellulosic feedstock. It may be included in the mixing chest or the blend chest of the papermaking process or into the thick stock prior to dilution. Alternatively the dry strength resin additive is added into the thin stock. This may be immediately after dilution of the thick stock or possibly after one of the fan pumps. The additive may be included after the centri screen but before draining although preferably it will be added before the centri screen.

The dry strength resin polymer may be added in a conventional amount, for instance at least 300 grams per tonne and possibly as much as 2 kg per tonne or more. Typical doses can be around 1 kg per tonne.

The polymer of the invention may be supplied as and used as an aqueous solution. In one form the polymer may be provided as a relatively concentrated aqueous solution, for instance having a concentration of above 2% by weight, for instance at least 5 or 10% by weight. The aqueous polymer solution may be used directly or instead it may be diluted to a relatively dilute concentration before use, for instance up 1% by weight or less, for instance between 0.05 and 0.5%, such as 0.1% by weight. Desirably, the polymer is in particulate form, for instance as a powder but preferably as a bead. The particulate polymer may be dissolved into water to form an aqueous solution having a concentration for instance as described above. In one further form, it may be desirable to use the particulate polymer directly in the process as a dry strength resin. Preferably the particulate polymer would be in the form of beads which are introduced into the process directly.

Typically drainage and retention aids can also be included in the process together with other additive is, for instance fixatives etc. A typical drainage and retention system may be a microparticle system such as the successful Ciba Hydrocol® process, which is described in EP-A-235893.

The polymeric additive used in the present invention may also be used as a wet strength resin during the papermaking process. The characteristics of the polymer will be chosen such that it has the capability to cross-link with itself and/or with the cellulose of the cellulosic fibres contained in the stock. We have found that polymer is containing residual reactive groups, particularly glycidyl groups can fulfil this requirement. During the papermaking process, once the cellulosic sheet is formed on the wire or mesh it is usually transferred to machinery which compress and dry the cellulosic sheet. The wet cellulosic sheet is usually transferred to a series of belts, such as the felts, on rollers. The wet cellulosic sheet needs to the sufficiently strong that it will not tear and remains intact during its processing, Significant improvements in wet strength can be observed by incorporating the polymeric additive into the papermaking process. When used as a wet strength additive the polymer can be incorporated in a similar manner as it would be for use as a dry strength additive.

In a further aspect of the invention the polymeric additive can be used as an internal sizing agent. Generally the characteristics of the polymer can be chosen such that when it is included in the papermaking process it modifies the water absorbing properties of the component fibres in the body of the sheet of paper that is formed such that they are less water absorbent. This is important since it prevents unacceptable levels of moisture and water from being absorbed by the paper sheet.

When used as an internal sizing agent that polymer is usually incorporated into the thin stock but this can also be into the thick stock or any of the stock components. It may be desirable to include the polymer in a sizing formulation. Such a formulation may be cationic in nature in order to make it more substantive to the fibres. It may also be desirable that the polymer is cationic and this may be achieved by producing a cationic synthetic polymeric component in which the water-soluble monomer component includes a cationic monomer.

The polymer described in the present invention when introduced into the cellulosic suspension of the papermaking process may function substantially simultaneously as a dry strength additive, a wet strength additive and also as an internal sizing agent.

In a still further form of the invention the polymeric additive is applied to the surface of the formed cellulosic sheet. Typically the additive would be applied to the cellulosic sheet once the cellulosic suspension has been drained on the machine wire or mesh. Preferably this will be before or during the drying stage. In this form of the invention the polymeric additive will desirably form a surface coating on at least one, and usually both, of the surfaces of the cellulosic sheet.

In a preferred aspect polymeric additive when applied to the surface of the cellulosic sheet is a surface sizing agent. Generally this is achieved by applying the polymer to the surface of the cellulosic sheet. Preferably, the polymer when used as an surface sizing agent is applied to the surface of the cellulosic sheet during or prior to drying. The surface sizing of a paper sheet ensures that the surface of the paper is rendered less water absorbent. Significant improvements in producing externally sized paper can be achieved using the polymer of the invention.

The surface sizing agent may be applied to the cellulosic sheet in conventional amounts. Typically this would be at least 50 grams per tonne of dry paper and maybe as much as 2 kg per tonne of dry paper, particularly within the range of between 300 grams per tonne and 1.5 kg per tonne.

In an additional aspect of the invention we provide a polymer which has been formed from a monomer blend comprising at least one water-soluble or potentially water-soluble ethylenically unsaturated monomer and up to 10 mole %, preferably up to 5 mole %, of a glycidyl monomer which is an ethylenically unsaturated monomer that carries a glycidyl group, wherein the polymer has a weight average molecular weight of below one million.

The polymer may include any of the aforementioned features described in regard to the polymeric additive used in the papermaking process. The polymer is particularly suitable for use as an additive in a papermaking process. It may for instance be used as a dry strength additive, wet strength additive, a internal sizing agent or as a surface sizing agent.

We have found that the polymer is particularly effective the monomer blend from which the polymer is formed comprises acrylamide or methacrylamide. Particularly preferred polymers include either glycidyl acrylate or glycidyl methacrylate as the glycidyl monomer.

In a preferred form, the polymer comprises at least 99.9 mole % acrylamide or methacrylamide and up to 0.1 mole % of the glycidyl acrylate or glycidyl methacrylate. More preferably the polymer is formed from a monomer blend that comprises between 99.990 and 99.999 mole % acrylamide or methacrylamide and between 0.001 and 0.01 mole % glycidyl acrylate or glycidyl methacrylate. Especially preferred is an acrylamide or methacrylamide content of between 99.990 and 99.995 mole %. Particularly preferred levels of glycidyl acrylate or glycidyl methacrylate range between 0.005 and 0.010 mole %.

The polymer of the invention may have a weight average molecular weight as low as a few thousand, for instance 6000 or 7000 or may be very high, for instance several tens of millions. However, we have found that when the polymer of the invention is for use as a dry strength additive in a paper making process it is preferred that the polymer has a weight average molecular weight of below 500,000, especially within the range 50,000 to 300,000, in particular between 100,000 and 150,000.

A preferred polymer has a combination of particular molecular weight range and ratios of acrylamide or methacrylamide to glycidyl acrylate or glycidyl methacrylate. Suitably such a polymer comprises at least 99.9 mole % acrylamide and up to 0.1 mole % of the glycidyl acrylate or glycidyl methacrylate and has a weight average molecular weight of between 100,000 and 200,000, preferably between 130,000 and 150,000.

The polymer may be prepared in accordance with the aforementioned manufacturing processes stated in regard to the polymeric additive used in the papermaking process.

The following examples illustrate the invention.

### EXAMPLES

### 1. Analytical Method

The polymers are analysed by size exclusion chromatography (SEC) using TSK PWXL columns (G6000+G3000+guard) or equivalents. The mobile phase is 0.2 molar sodium chloride (NaCl) with 0.05 molar dipotassium hydrogen phosphate (K₂HPO₄) in purified water that is pumped through the system at a nominal flow rate of 0.5 ml/min.

The polymers have little UV activity at 280 nm but absorb strongly at 210 nm due to the carbonyl chromophore. Molecular weight values and molecular weight distributions of the polymers are determined by detection at 210 nm by calibration of the columns with a set of sodium polyacrylate standards with known molecular weight characteristics. The retention time of each standard in the SEC system is measured and a plot is made of the logarithm of the peak molecular weight versus the retention time.

### 2. Polymer Synthesis

### General Method

1. Into a suitable reaction vessel place water, and diethylenetriaminepentaacetic acid, penta sodium salt (DETAPA)
2. Raise the temperature of the contents and maintain at 80° C.
3. Add initiator (1) to reaction vessel
4. Introduce a solution of the monomer and also a solution of initiator (2) into the reaction vessel immediately after the introduction of initiator [1].
5. After all that monomer and initiator have been introduced continued stir the contents of the reaction vessel for a further 30 minutes maintaining a temperature of 80° C.

Synthesis of an Acrylamide: Glycidyl
Methacrylate Polymer (99:1 mole ratio)

| Reaction vessel: | Water | 350.0 | g |
|---|---|---|---|
| | (DETAPA) @6% | 0.5 | mls |
| | (acetic acid to ~pH 5) | | |
| Initiator (1) | Ammonium persulphate | 0.431 g in 10 mls water | |
| Monomer: | Acrylamide @50% | 396.0 | g |
| | Glycidyl methacrylate | 4.13 | g |
| | @97% | | |
| | Water | 199.87 | g |

| | | |
|---|---|---|
| Initiator (2) | Ammonium persulphate | 0.569 g in 50 mls of water. |
| (2.25 hour feed): | | |

### 3. Preparation of Paper Handsheets Using Polymer Reacted CBD

### Stock Preparation

A 50:50 long:short fibre stock is prepared with 10% filler at a consistency of 1.8% and beaten to a Freeness of 45SR.

### Polymer Evaluation—Tensile Strength

The stock is stirred at 1000 rpm and the polymer (0.1%) is added at 1 kg/t with mixing for 30 seconds.

The stock is then diluted to 0.5% and 5×300 ml aliquots taken.

Each aliquot is dosed with Percol 182 cationic polyacrylamide of intrinsic viscosity above 7 dl/g (500 g/t) with stirring at 1500 rpm for 30 seconds, before addition of Hydrocol O sodium bentonite (2 kg/t) with further mixing at 500 rpm for 15 seconds. Handsheets are then produced using a British Standard Handsheet maker and 5 handsheets are produced per sample. Each handsheet has a strip (2.5 cm width) cut from it and the individual strips conditioned in accordance with Tappi test method T402 (Standard conditioning and testing atmospheres for paper, board, pulp handsheets and related products).

The conditioned strips are then tested in accordance with Tappi test method T494 (Tensile breaking properties of paper and paperboard) using a Testometric 220D.

### Polymers Evaluated

The polymers that are used were polyacrylamide-glycidylmethacrylate copolymers with varying degrees of the reactive glycidylmethacrylate units as shown in the following table:

| | Mole % of | % Initiator | | |
|---|---|---|---|---|
| | glycydylmethacrylate | used on | | Dry Weight |
| No | units | monomer | Mw | (%) |
| 2 | 1 | 0.75 | 279000 | 22.9 |
| 3 | 1 | 1 | 197000 | 23.5 |
| 4 | 0.1 | 0.5 | 253000 | 24.0 |
| 5 | 0.1 | 0.75 | 216000 | 23.5 |
| 6 | 0.1 | 1 | 148000 | 23.1 |
| 7 | 0.01 | 0.5 | 140000 | 22.0 |
| 8 | 0.01 | 0.75 | 111000 | 22.8 |
| 9 | 0.01 | 1 | 155000 | 23.3 |

### Results of Tensile Measurements;

| | Ash Weight (%) | Tensile Index |
|---|---|---|
| Sample No | (Mean) | (Mean) |
| Blank (no polymer) | 10.49 | 46.34 |
| 2 | 9.97 | 56.25 |
| 3 | 10.02 | 50.20 |
| 4 | 9.86 | 52.87 |
| 5 | 9.91 | 57.60 |
| 6 | 10.06 | 54.40 |
| 7 | 9.86 | 58.98 |
| 8 | 9.59 | 50.59 |
| 9 | 9.75 | 56.45 |
| 8 (adjusted to pH 10) | 9.29 | 50.29 |

The polymeric additive proved to be an effective dry strength resin and shows that polyacrylamide-glycidylmethacrylate copolymers can act as effective dry strength resins.

1. A process of making paper by providing a cellulosic suspension comprising cellulosic fibres and optionally fillers, dewatering the cellulosic suspension on a wire or mesh to form a sheet and drying the sheet in which a polymeric additive is included in the process,
in which the polymeric additive is a polymer comprising an ethylenically unsaturated water-soluble or potentially water-soluble monomer and an ethylenically unsaturated monomer carrying a reactive group.

2. A process according to claim 1 in which the reactive group is selected from the group consisting of epoxides, isocyanates, and amido methylol groups.

3. A process according to claim 1 in which the polymer is formed from a monomer blend comprising at least one water-soluble or potentially water-soluble ethylenically unsaturated monomer; up to 10 mole % ethylenically unsaturated monomer carrying a reactive group.

4. A process according to claim 1 in which the polymer is formed from a monomer blend comprising acrylamide and glycidyl methacrylate.

5. A process according to claim 1 in which the polymer has a weight average molecular weight of below one million.

6. A process according to claim 1 in which the polymeric additive is a dry strength additive.

7. A process according claim 1 in which the polymeric additive is a wet strength additive.

8. A process according to claim 1 in which the polymeric additive is an internal sizing agent.

9. A process according to claim 1 in which the polymeric additive is applied to the surface of the formed cellulosic sheet and in which the polymeric additive is a surface sizing agent.

10. A polymer which has been formed from a monomer blend comprising at least one water-soluble or potentially water-soluble ethylenically unsaturated monomer and up to 10 mole % of a glycidyl monomer which is an ethylenically unsaturated monomer that carries a glycidyl group,
wherein the polymer has a weight average molecular weight of below one million.

11. A polymer according to claim 10 in which the monomer blend comprises acrylamide or methacrylamide.

12. A polymer according to claim 10 in which the glycidyl monomer is either glycidyl acrylate or glycidyl methacrylate.

13. A polymer according to claim 10 in which the polymer comprises at least 99.9 mole % acrylamide and up to 0.1 mole % of the glycidyl acrylate or glycidyl methacrylate.

14. A polymer according to claim 10 in which the polymer has a weight average molecular weight of between 50,000 and 300,000.

15. A method of improving the dry strength characteristics paper by incorporating a polymer in the paper making process in which the polymer has been formed from a monomer blend comprising at least one water-soluble or potentially water-soluble ethylenically unsaturated monomer and up to 10 mole %, preferably up to 5 mole %, of a glycidyl monomer which is an ethylenically unsaturated monomer that carries a glycidyl group, wherein the polymer has a weight average molecular weight of below one million.

16. A method of improving the wet strength characteristics of a paper by adding a during the paper making process in which the polymer has been formed from a monomer blend comprising at least one water-soluble or potentially water-soluble ethylenically unsaturated monomer and up to 10 mole % of a glycidyl monomer which is an ethylenically unsaturated monomer that carries a glycidyl group, wherein the polymer has a weight average molecular weight of below one million.

17. A method of internal sizing paper by incorporating a polymer in a paper making process in which the polymer has been formed from a monomer blend comprising at least one water-soluble or potentially water-soluble ethylenically unsaturated monomer and up to 10 mole % of a glycidyl monomer which is an ethylenically unsaturated monomer that carries a glycidyl group,
wherein the polymer has a weight average molecular weight of below one million.

18. A method of surface sizing a paper by applying a polymer to the surface of a cellulosic sheet in which the polymer has been formed from a monomer blend comprising at least one water-soluble or potentially water-soluble ethylenically unsaturated monomer and up to 10 mole % of a glycidyl monomer which is an ethylenically unsaturated monomer that carries a glycidyl group, wherein the polymer has a weight average molecular weight of below one million.
